(19) United States
(12) Patent Application Publication
(10) Pub. No.: US 2024/0168404 A1
(43) Pub. Date: May 23, 2024

(54) LIGHT SOURCE DEVICE HAVING POSITIONING PART ON HOLDER FOR POSITIONING OF COUPLING LENS RELATIVE THERETO, AND SCANNING OPTICAL DEVICE USING THE SAME

(71) Applicant: BROTHER KOGYO KABUSHIKI KAISHA, Nagoya (JP)

(72) Inventors: Junichi YOKOI, Nagoya (JP); Yoshihiro OYAMA, Tokai (JP)

(73) Assignee: BROTHER KOGYO KABUSHIKI KAISHA, Nagoya (JP)

(21) Appl. No.: 18/494,452

(22) Filed: Oct. 25, 2023

(30) Foreign Application Priority Data
Nov. 18, 2022 (JP) 2022-184681

(51) Int. Cl. G03G 15/04; G02B 26/12

(52) U.S. Cl. CPC G03G 15/04036; G02B 26/124

(57) ABSTRACT

A light source device includes: a semiconductor laser configured to emit light; a coupling lens configured to convert the light from the semiconductor laser into light beam; and a holder supporting the coupling lens. The coupling lens has: an optical surface defining an optical axis; and a flange portion protruding outward in a radial direction orthogonal to the optical axis. The flange portion includes: a first flange portion having an arcuate surface centered on the optical axis; and a second flange portion having a flat surface extending along the optical axis. The holder has: a first positioning part opposing the arcuate surface in the radial direction for positioning of the coupling lens; and a first notch through which a part of the flat surface is exposed in the radial direction. At least a part of the first flange portion is bonded to the holder.

### REFERENCE TO RELATED APPLICATIONS

This application claims priority from Japanese Patent Application No. 2022-184681 filed on Nov. 18, 2022. The entire content of the priority application is incorporated herein by reference.

### BACKGROUND ART

One conventional light source device for use in an image-forming apparatus is provided with a coupling lens, and a holder that holds the coupling lens. In this technology, the coupling lens has a convex optical surface, and a flange portion that protrudes from the optical surface in a radial direction of the same. Including the flange portion, the coupling lens has an axisymmetric shape.

### DESCRIPTION

Here, if the coupling lens being used has an outer shape that is not axisymmetric, the orientation of the lens about its optical axis must be defined when bonding the lens to the holder. Specifically, the orientation of a lens about its optical axis must be defined when the optical surface of the lens is not axisymmetric. This holds true even when the optical surface is axisymmetric by design, as the aberration could vary.

In view of the foregoing, it is an object of the present invention to provide a light source device capable of setting the orientation of a coupling lens around an optical axis thereof.

In order to attain the above and other objects, according to one aspect, the present disclosure provides a light source device including a semiconductor laser, a coupling lens, and a holder. The semiconductor laser is configured to emit light. The coupling lens is configured to convert the light from the semiconductor laser into light beam. The holder supports the coupling lens. The coupling lens has: an optical surface defining an optical axis; and a flange portion protruding outward in a radial direction orthogonal to the optical axis. The flange portion includes a first flange portion, and a second flange portion. The first flange portion has an arcuate surface centered on the optical axis. The second flange portion has a flat surface extending in a direction along the optical axis. The holder has a first positioning part and a first notch. The first positioning part opposes the arcuate surface in the radial direction for positioning of the coupling lens relative to the holder. At least a part of the flat surface is exposed in the radial direction through the first notch. At least a part of the first flange portion is bonded to the holder.

By arranging at least a portion of the flat surface on the second flange portion to be exposed through the first notch, the surface of the second flange portion can be operated with a jig or the like, thereby setting the orientation of the coupling lens around the optical axis.

According to another aspect, the present disclosure also provides a scanning optical device including a semiconductor laser, a coupling lens, a holder, a deflector, a scanning optical system, and a frame. The semiconductor laser is configured to emit light. The coupling lens is configured to convert the light from the semiconductor laser into light beam. The holder supports the coupling lens. The deflector includes a polygon mirror configured to deflect the light beam. The scanning optical system is configured to form an image on an image plane using the light beam from the polygon mirror. The semiconductor laser, the coupling lens, the holder, the deflector and the scanning optical system are fixed to the frame. The coupling lens has: an optical surface defining an optical axis; and a flange portion protruding outward in a radial direction orthogonal to the optical axis. The flange portion includes a first flange portion, and a second flange portion. The first flange portion has an arcuate surface centered on the optical axis. The second flange portion has a flat surface extending in a direction along the optical axis. The holder has a first positioning part, and a first notch. The first positioning part opposes the arcuate surface in the radial direction for positioning of the coupling lens relative to the holder. At least a part of the flat surface is exposed in the radial direction through the first notch. At least a part of the first flange portion is bonded to the holder.

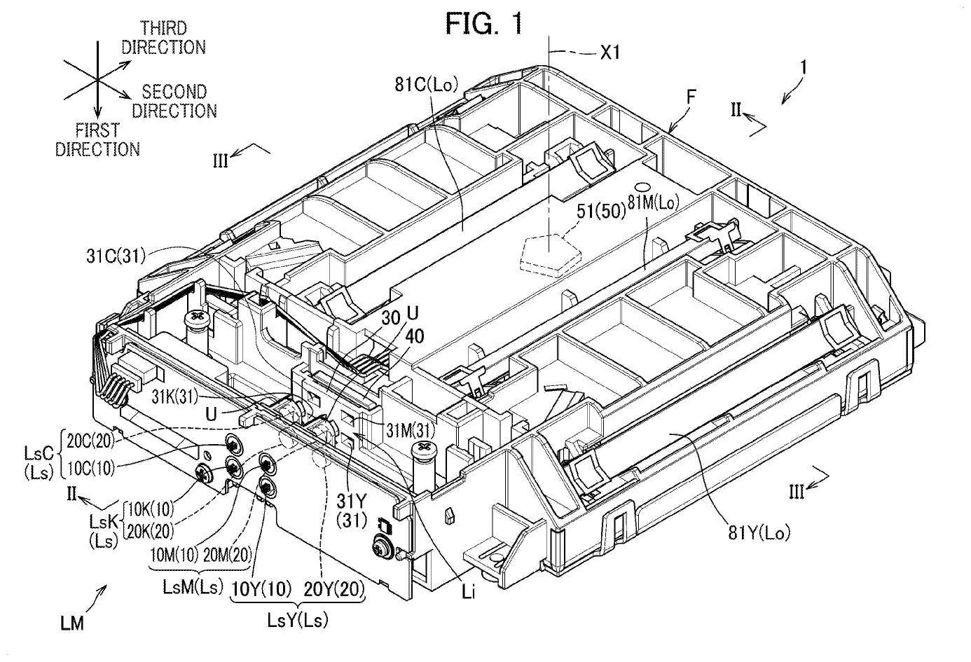

FIG. 1 is a perspective view of a scanning optical device incorporating a light source device according to one embodiment of the disclosure.

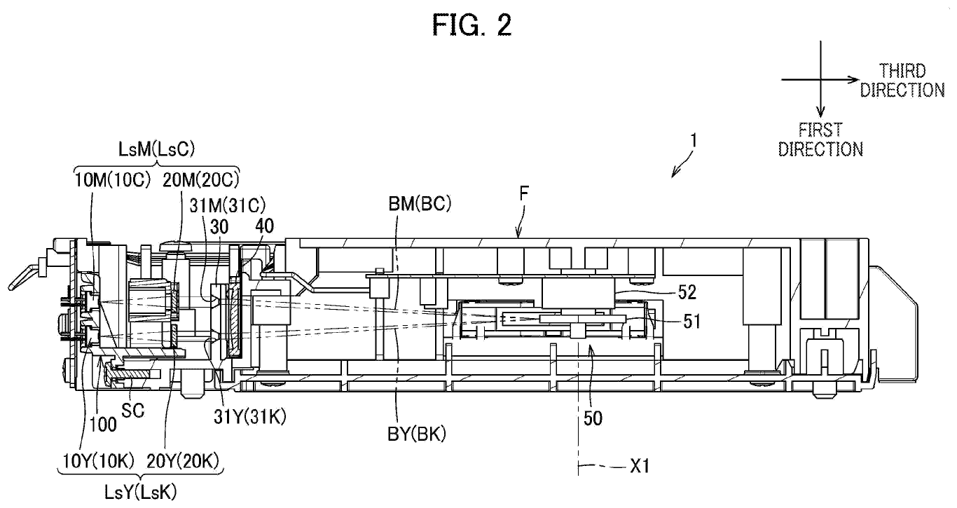

FIG. 2 is a cross-sectional view taken along a plane II-II in FIG. 1.

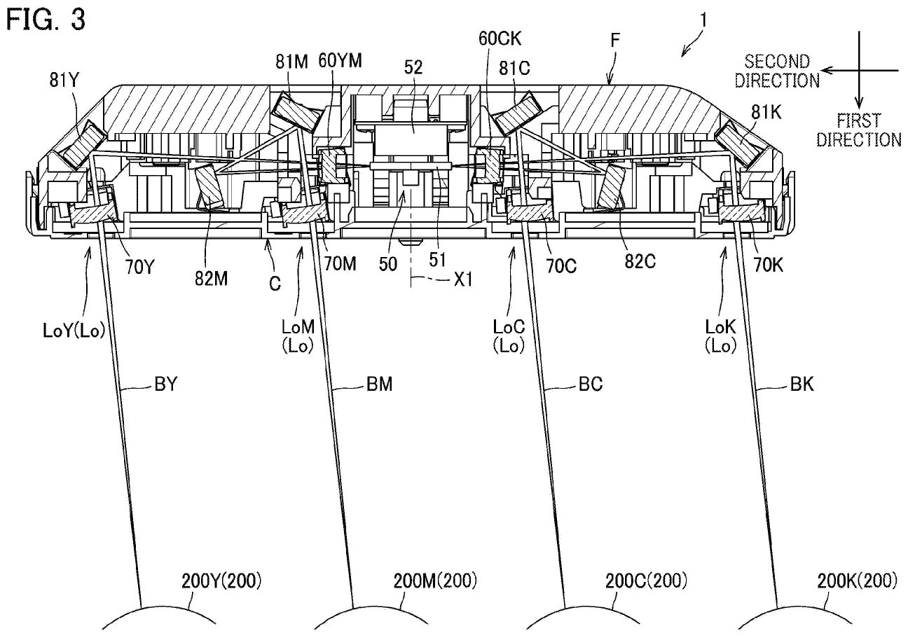

FIG. 3 is a cross-sectional view taken along a plane III-III in FIG. 1.

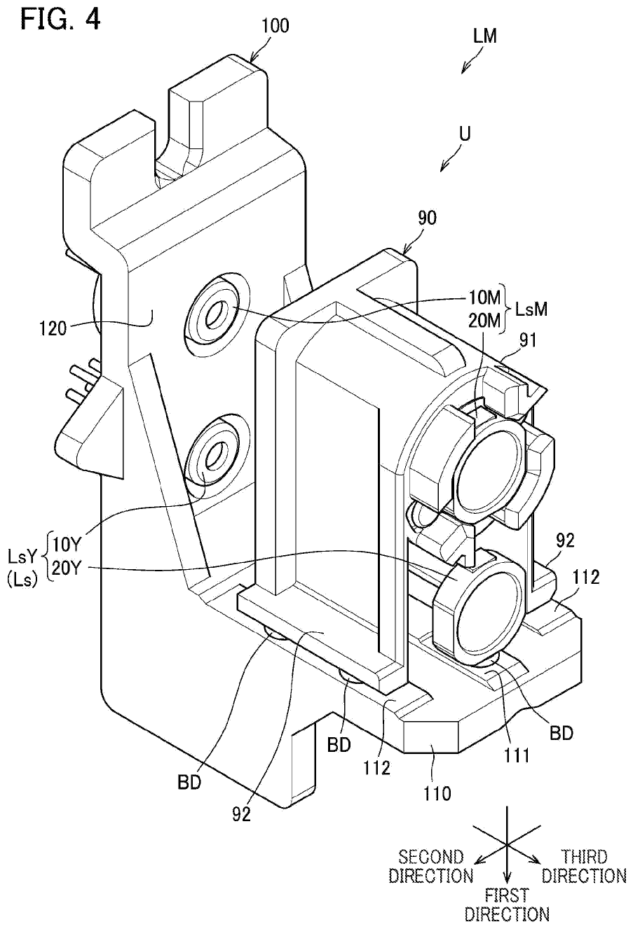

FIG. 4 is a perspective view of an optical unit constituting the light source device.

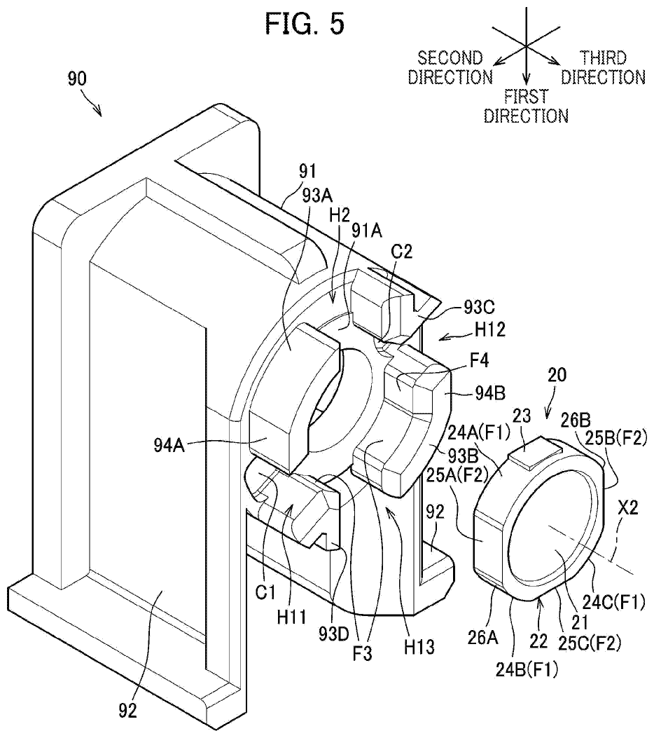

FIG. 5 is an exploded perspective view illustrating a holder and a coupling lens in the optical unit.

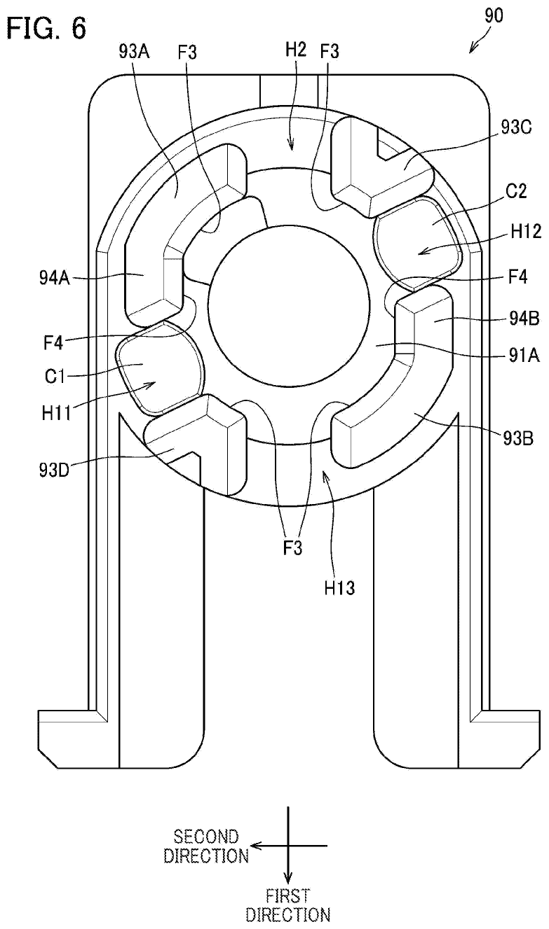

FIG. 6 is a view of the holder when viewed from one side in the third direction.

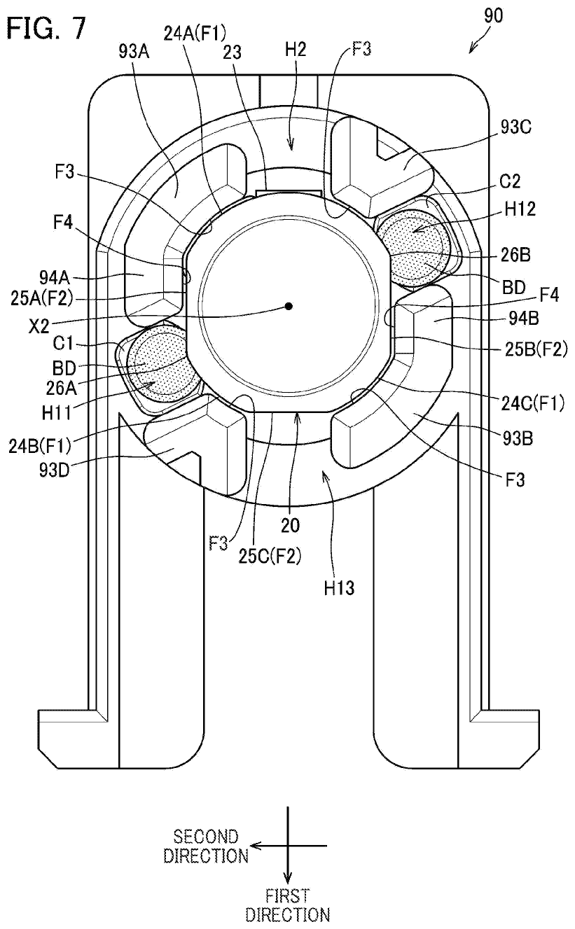

FIG. 7 is a view illustrating the holder to which the coupling lens is attached when viewed from the one side in the third direction.

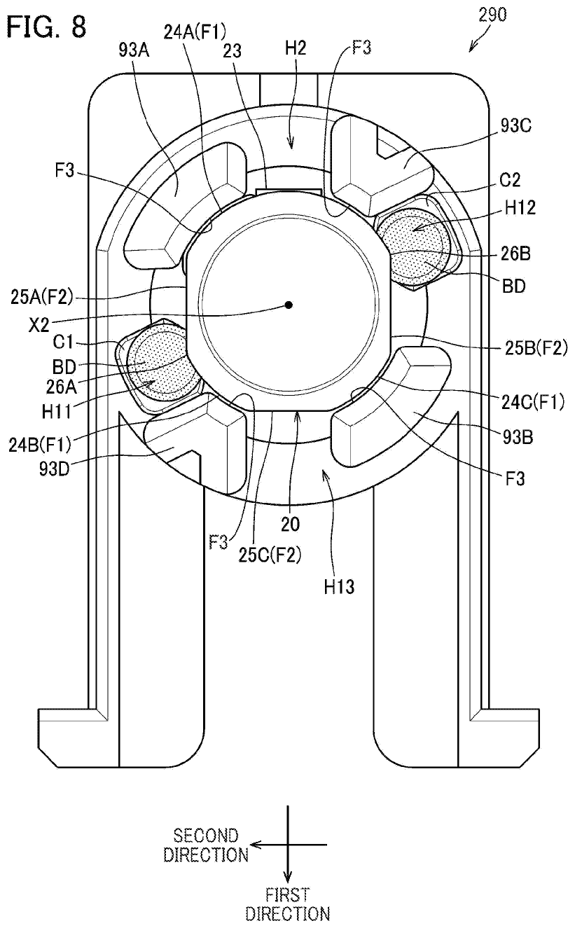

FIG. 8 is a view illustrating a holder according to a modification to the embodiment.

FIG. 1 shows a scanning optical device 1 provided with a light source device LM according to one embodiment of the disclosure. As illustrated in FIG. 1, the scanning optical device 1 includes a frame F, an incident optical system Li, a deflector 50, and scanning optical systems Lo. In the present embodiment, the scanning optical device 1 is employed in an electrophotographic image-forming apparatus. The image-forming apparatus includes four photosensitive drums 200 (see FIG. 3).

In the following description, a direction parallel to a rotational axis X1 of a polygon mirror 51 described later will be called a “first direction.” Further, a direction in which the polygon mirror 51 is aligned with a first scanning lens 60YM (see FIG. 3) and that is orthogonal to the first direction will be called a “second direction.” Further, a direction orthogonal to both the first and second directions will be called a “third direction.” The third direction corresponds to a main scanning direction, and the first direction corresponds to a sub scanning direction of the incident optical system Li.

Further, arrows in the drawings for these directions each point to one side of the respective direction. Specifically, in the following description, “one end” or “one end portion” implies a component at the one side in the corresponding direction (a leading side of the arrow), and “another end” or “another end portion” implies a component at another side in the corresponding direction (a trailing side of the arrow).

The incident optical system Li mainly includes the light source device LM, an aperture plate 30, and a condenser lens 40.

The light source device LM includes four light sources Ls. Each light source Ls is a device for emitting light beams. Each light source Ls includes a semiconductor laser 10, and a coupling lens 20.

The semiconductor laser 10 is a device configured to emit laser light. Four of the semiconductor lasers 10 are provided for the corresponding four photosensitive drums 200 (see FIG. 3) which are configured to be scanned and exposed by the scanning optical device 1. Toner images in different colors are formed on the respective photosensitive drums 200.

In the present embodiment, among the four different colors of toner, the first color will be yellow (Y), the second color will be magenta (M), the third color will be cyan (C), and the fourth color will be black (K). In the following description, parts related to the first color may be distinguished by adding “first” to the beginning of the part name and “Y” to the end of the reference numeral for the corresponding part. Similarly, parts related to the second, third, and fourth colors may be distinguished by adding “second,” “third,” and “fourth,” respectively, to the beginning of the part name and “M”, “C”, and “K”, respectively, to the end of the reference numeral.

The semiconductor lasers 10 include a first semiconductor laser 10Y corresponding to yellow, a second semiconductor laser 10M corresponding to magenta, a third semiconductor laser 10C corresponding to cyan, and a fourth semiconductor laser 10K corresponding to black. The first semiconductor laser 10Y is spaced apart from the second semiconductor laser 10M in the first direction. The first semiconductor laser 10Y is positioned on the one side of the second semiconductor laser 10M in the first direction.

The third semiconductor laser 10C is spaced apart from the second semiconductor laser 10M in the second direction. The third semiconductor laser 10C is positioned on the other side of the second semiconductor laser 10M in the second direction. The fourth semiconductor laser 10K is spaced apart from the third semiconductor laser 10C in the first direction and is spaced apart from the first semiconductor laser 10Y in the second direction.

The coupling lenses 20 are configured to convert laser light emitted from the respective semiconductor lasers 10 into light beams. The coupling lenses 20Y, 20M, 20C, and 20K corresponding to the four colors are positioned to oppose the corresponding semiconductor lasers 10Y, 10M, 10C, and 10K.

The aperture plate 30 has aperture diaphragms 31 through which the light beams exiting the coupling lenses 20 pass. In this embodiment, the aperture plate 30 is formed integrally with the frame F. The aperture plate 30 is located between the coupling lenses 20 and the condenser lens 40. Four aperture diaphragms 31Y, 31M, 31C, and 31K are provided to correspond to the four light sources LsY, LsM, LsC, and LsK.

The condenser lens 40 focuses the light beams emitted from the respective coupling lenses 20 onto mirror surfaces of the polygon mirror 51 in the sub scanning direction. The condenser lens 40 is positioned opposite the coupling lenses 20 with respect to the aperture plate 30.

As illustrated in FIG. 2, the deflector 50 is a device configured to deflect the light beams from the light sources Ls in the main scanning direction (third direction). The deflector 50 includes the polygon mirror 51, and a motor 52. The polygon mirror 51 deflects the light beams in the main scanning direction by rotating. The polygon mirror 51 has five mirror surfaces equidistant from the rotational axis X1 (see also FIG. 1). The motor 52 is configured to rotate the polygon mirror 51. The motor 52 is fixed to the frame F.

As illustrated in FIG. 3, the scanning optical systems Lo function to form images on surfaces of the corresponding photosensitive drums 200, as image planes, using the light beams deflected by the deflector 50. Components of each scanning optical system Lo are fixed to the frame F. The scanning optical systems Lo include a first scanning optical system LoY corresponding to yellow, a second scanning optical system LoM corresponding to magenta, a third scanning optical system LoC corresponding to cyan, and a fourth scanning optical system LoK corresponding to black.

The first scanning optical system LoY and second scanning optical system LoM are disposed on the one side of the polygon mirror 51 in the second direction. The third scanning optical system LoC and fourth scanning optical system LoK are disposed on the other side of the polygon mirror 51 in the second direction. Light beams deflected in the main scanning direction by the polygon mirror 51 are incident on the corresponding scanning optical systems LoY, LoM, LoC, and LoK.

The first scanning optical system LoY includes the first scanning lens 60YM, a second scanning lens 70Y, and a reflecting mirror 81Y.

The first scanning lens 60YM refracts light beams BY and BM deflected by the deflector 50 in the main scanning direction to form images on the corresponding photosensitive drums 200Y and 200M. The first scanning lens 60YM has fe characteristics that make the light beams BY and BM scanned at an equal angular velocity by the deflector 50 move at an equal velocity over the photosensitive drums 200Y and 200M.

The reflecting mirror 81Y reflects the light beam BY exiting the first scanning lens 60YM toward the first photosensitive drum 200Y.

The second scanning lens 70Y refracts the light beam BY reflected by the reflecting mirror 81Y in the sub scanning direction to form an image on the first photosensitive drum 200Y. In the scanning optical system Lo, the sub scanning direction corresponds to a direction orthogonal to both the main scanning direction and the direction in which the light beam travels. The second scanning lens 70Y is positioned on the one side of the polygon mirror 51 in the first direction.

The second scanning optical system LoM includes the first scanning lens 60YM, a second scanning lens 70M, a reflecting mirror 81M, and a mirror 82M.

The first scanning lens 60YM of the second scanning optical system LoM is shared with the first scanning optical system LoY. The mirror 82M reflects the light beam BM exiting the first scanning lens 60YM onto the reflecting mirror 81M. The second scanning lens 70M and the reflecting mirror 81M have the same functions as the second scanning lens 70Y and reflecting mirror 81Y in the first scanning optical system LoY. In other words, the reflecting mirror 81M reflects the light beam BM reflected off the mirror 82M toward the second photosensitive drum 200M, and the second scanning lens 70M refracts the light beam BM reflected by the reflecting mirror 81M in the sub scanning direction to form an image on the second photosensitive drum 200M.

The third scanning optical system LoC has an approximate symmetrical configuration to the second scanning optical system LoM about the rotational axis X1 of the polygon mirror 51. Specifically, the third scanning optical system LoC includes a first scanning lens 60CK, a second scanning lens 70C, a reflecting mirror 81C, and a mirror 82C, which possess the same functions as the components in the second scanning optical system LoM.

The first scanning lens 60CK refracts light beams BC and BK deflected by the deflector 50 in the main scanning direction to form images on the corresponding photosensitive drums 200C and 200K. The first scanning lens 60CK has fe characteristics that make the light beams BC and BK scanned at an equal angular velocity by the deflector 50 move at an equal velocity over the photosensitive drums 200C and 200K.

The mirror 82C reflects the light beam BC exiting the first scanning lens 60CK onto the reflecting mirror 81C, and the reflecting mirror 81C reflects the light beam BC reflected by the mirror 82C toward the third photosensitive drum 200C. The second scanning lens 70C refracts the light beam BC reflected by the reflecting mirror 81C in the sub scanning direction to form an image on the third photosensitive drum 200C.

The fourth scanning optical system LoK has an approximately symmetrical configuration to the first scanning optical system LoY about the rotational axis X1 of the polygon mirror 51. Specifically, the fourth scanning optical system LoK includes the first scanning lens 60CK, a second scanning lens 70K, and a reflecting mirror 81K, which possess the same functions as the components in the first scanning optical system LoY.

The reflecting mirror 81K reflects the light beam BK exiting the first scanning lens 60CK toward the fourth photosensitive drum 200K, and the second scanning lens 70K refracts the light beam BK reflected by the reflecting mirror 81K in the sub scanning direction to form an image on the fourth photosensitive drum 200K.

As illustrated in FIG. 2, laser light emitted from each of the semiconductor lasers 10Y, 10M, 10C, and 10K is converted to the light beams BY, BM, BC, and BK when passing through the corresponding coupling lenses 20Y, 20M, 20C, and 20K. The light beams BY, BM, BC, and BK emitted from each of the light sources LsY, LsM, LsC, and LsK pass first through the corresponding aperture diaphragms 31Y, 31M, 31C, and 31K of the aperture plate 30 and then through the condenser lens 40 before being incident on the polygon mirror 51. The condenser lens 40 is a shared lens through which each of the light beams BY, BM, BC, and BK pass. The incident surface of the condenser lens 40 is a cylindrical surface, while the emitting surface is flat.

As illustrated in FIG. 3, the polygon mirror 51 deflects the light beams BY, BM, BC, and BK toward the corresponding scanning optical systems LoY, LoM, LoC, and LoK. The light beam BY deflected toward the first scanning optical system LoY passes through the first scanning lens 60YM, is reflected by the reflecting mirror 81Y, and is emitted through the second scanning lens 70Y toward the first photosensitive drum 200Y. The light beam BY exits the second scanning lens 70Y at a predetermined angle to the first direction. The light beam BY forms an image on the surface of the first photosensitive drum 200Y while being scanned in the main scanning direction.

The light beam BM deflected toward the second scanning optical system LoM first passes through the first scanning lens 60YM, is reflected by the mirror 82M and reflecting mirror 81M, and is emitted through the second scanning lens 70M toward the second photosensitive drum 200M. The light beam BM exits the second scanning lens 70M at a predetermined angle to the first direction. The light beam BM forms an image on the surface of the second photosensitive drum 200M while being scanned in the main scanning direction. The light beams BC and BK are similarly emitted by the corresponding scanning optical systems LoC and LoK toward the corresponding photosensitive drums 200C and 200K and form images on the corresponding photosensitive drums 200C and 200K while being scanned in the main scanning direction.

As shown in FIG. 4, the light source device LM includes light source units U. Each light source unit U holds two light sources Ls aligned in the first direction. As shown in FIG. 1, the light source device LM includes two light source units U aligned in the second direction. Since both of the light source units U are similar in structure, only one light source unit U will be described below as a representative example.

The light source unit U includes a holder 90, and a laser holder 100. The holder 90 is a member that holds the coupling lens 20M, which is, among the two coupling lenses 20Y and 20M that are aligned in the first direction, the one positioned on the other side in the first direction.

The laser holder 100 has a first portion 110, and a second portion 120. The first portion 110 is a plate-like portion whose thickness direction is aligned in the first direction. The first portion 110 has a first seating surface 111, and two second seating surfaces 112.

The first seating surface 111 is a surface for holding the coupling lens 20Y, which among the two coupling lenses 20Y and 20M that are aligned in the first direction is the one positioned at the one side in the first direction. The coupling lens 20Y is fixed to the first seating surface 111 by an adhesive BD formed of a photocurable resin. The first seating surface 111 is positioned between the two second seating surfaces 112 in the second direction.

The second seating surfaces 112 function to hold the holder 90. The holder 90 is affixed to the second seating surfaces 112 with adhesive BD.

The second portion 120 extends toward the other side in the first direction from an end of the first portion 110 at the other side in the third direction. The second portion 120 holds the two semiconductor lasers 10Y and 10M that are aligned in the first direction. As shown in FIG. 2, the laser holder 100 is fixed to the frame F by screws SC.

As shown in FIG. 5, each coupling lens 20 has an optical surface 21, a flange portion 22, and a gate trace 23.

The optical surface 21 is circular when viewed in a direction along an optical axis X2 of the coupling lens 20.

The flange portion 22 protrudes from a radial edge of the optical surface 21 outward in radial directions orthogonal to the optical axis X2. In other words, the flange portion 22 is positioned on a periphery, and specifically on the radial edge, of the optical surface 21.

The flange portion 22 has three first flange portions 24A, 24B, and 24C, and three second flange portions 25A, 25B, and 25C. Each of the first flange portions 24A, 24B, and 24C has an arcuate surface F1 centered on the optical axis X2. Each of the second flange portions 25A, 25B, and 25C has a flat surface F2 aligned in the direction along the optical axis X2.

The second flange portion 25A is positioned on one end of the coupling lens 20 in the second direction. The second flange portion 25B is positioned on another end of the coupling lens 20 in the second direction. The flat surfaces F2 of the second flange portions 25A and 25B are orthogonal to the second direction. The second flange portions 25A and 25B are axisymmetric with respect to the optical axis X2.

The second flange portion 25C is positioned on one end of the coupling lens 20 in the first direction. The flat surface F2 of the second flange portion 25C is orthogonal to the respective flat surfaces F2 of the second flange portions 25A and 25B.

The first flange portion 24A is positioned on another end of the coupling lens 20 in the first direction. The first flange portion 24A extends from the second flange portion 25A at the one end in the second direction to the second flange portion 25B at the other end in the second direction. The first flange portion 24B is positioned between the second flange portion 25A and the second flange portion 25C. The first flange portion 24C is positioned between the second flange portion 25B and the second flange portion 25C.

The gate trace 23 is a part formed integrally with the coupling lens 20 when the coupling lens 20 is formed through injection molding. The gate trace 23 protrudes radially outward from the arcuate surface F1 of the first flange portion 24A. The gate trace 23 is positioned opposite the second flange portion 25C with respect to the optical axis X2.

The coupling lens 20 further has a first corner portion 26A, and a second corner portion 26B. The first corner portion 26A is formed by the flat surface F2 of the second flange portion 25A and the arcuate surface F1 of the first flange portion 24B. The second corner portion 26B is formed by the flat surface F2 of the second flange portion 25B and the arcuate surface F1 of the first flange portion 24A. The first corner portion 26A and second corner portion 26B are positioned on opposite sides of the optical axis X2.

The holder 90 has a base 91, two legs 92, four first positioning parts 93A, 93B, 93C, and 93D, and two second positioning parts 94A and 94B. The base 91 has one end in the third direction formed with a lens seating surface 91A. The lens seating surface 91A contacts the flange portion 22 of the coupling lens 20 (20M) in the third direction.

The legs 92 extend from the base 91 toward the one side in the first direction. As shown in FIG. 4, each leg 92 is fixed to the corresponding second seating surface 112 of the laser holder 100 by adhesive BD.

Returning to FIG. 5, the first positioning parts 93A, 93B, 93C, and 93D and the second positioning parts 94A and 94B protrude toward the one side in the third direction from the lens seating surface 91A. Specifically, the first positioning parts 93A, 93B, 93C, and 93D are walls extending in parallel to the optical axis X2 (i.e., in the third direction). The first positioning parts 93A, 93B, 93C, and 93D are configured to contact the coupling lens 20 from radially outward thereof. The first positioning parts 93A, 93B, 93C, and 93D function to position the coupling lens 20 in radial directions thereof.

As shown in FIG. 7, the first positioning part 93A radially opposes a part of the arcuate surface F1 of the first flange portion 24A at the one side in the second direction. The first positioning part 93B radially opposes the arcuate surface F1 of the first flange portion 24C.

The first positioning part 93C radially opposes another part of the arcuate surface F1 of the first flange portion 24A at the other side in the second direction. The first positioning part 93D radially opposes the arcuate surface F1 of the first flange portion 24B.

The optical axis X2 is positioned between the two first positioning parts 93A and 93B. The optical axis X2 is also positioned between the two first positioning parts 93C and 93D. In other words, the two first positioning parts 93A and 93B sandwich the coupling lens 20 in a first radial direction orthogonal to the optical axis X2. Similarly, the two first positioning parts 93C and 93D sandwich the coupling lens 20 in a second radial direction orthogonal to the optical axis X2 that is different from the first radial direction.

As shown in FIGS. 6 and 7, the first positioning part 93A has a curved surface F3 that conforms to the arcuate surface F1 of the first flange portion 24A. The first positioning part 93B also has a curved surface F3 that conforms to the arcuate surface F1 of the first flange portion 24C (see also FIG. 5). The first positioning part 93C has a curved surface F3 that conforms to the arcuate surface F1 of the first flange portion 24A. The first positioning part 93D has a curved surface F3 that conforms to the arcuate surface F1 of the first flange portion 24B (see also FIG. 5).

The second positioning parts 94A and 94B function to determine the orientation of the coupling lens 20 around the optical axis X2. The second positioning part 94A extends toward the one side in the first direction from an end of the first positioning part 93A at the one side in the second direction. The second positioning part 94B extends toward the other side in the first direction from an end of the first positioning part 93B at the other side in the second direction.

The second positioning part 94A opposes the flat surface F2 of the second flange portion 25A of the coupling lens 20. The second positioning part 94A has a second flat surface F4 that opposes the flat surface F2 of the second flange portion 25A.

The second positioning part 94B opposes the flat surface F2 of the second flange portion 25B of the coupling lens 20. The second positioning part 94B has a second flat surface F4 opposing the flat surface F2 of the second flange portion 25B (see also FIG. 5).

The holder 90 further has three first notches H11, H12, and H13, and a second notch H2. The three first notches H11, H12, and H13 and the second notch H2 are recessed toward the other side in the third direction relative to the first positioning parts 93A, 93B, 93C, and 93D.

The first notch H11 functions to expose a portion of the flat surface F2 on the second flange portion 25A of the coupling lens 20 and a portion of the arcuate surface F1 on the first flange portion 24B in the radial directions. The first notch H11 is positioned between the second positioning part 94A and the first positioning part 93D.

The first notch H12 functions to expose a portion of the flat surface F2 on the second flange portion 25B and a portion of the arcuate surface F1 on the first flange portion 24A in the radial directions. The first notch H12 is positioned between the first positioning part 93C and the second positioning part 94B.

The first notch H13 functions to expose substantially an entirety of the flat surface F2 of the second flange portion 25C in the radial direction. The first notch H13 is positioned between the first positioning part 93D and the first positioning part 93B.

The second notch H2 exposes the gate trace 23 in the radial direction. The second notch H2 is positioned between the first positioning part 93A and the first positioning part 93C.

As shown in FIGS. 5 and 6, the holder 90 further has two recesses C1 and C2. The recesses C1 and C2 are recessed toward the other side in the third direction from the lens seating surface 91A. The recess C1 is positioned between the second positioning part 94A and the first positioning part 93D. The recess C2 is positioned between the first positioning part 93C and the second positioning part 94B.

When the coupling lens 20 is mounted in the holder 90, as illustrated in FIG. 7, the recesses C1 and C2 are recessed in a direction away from the first flange portions 24A and 24B in the direction along the optical axis X2. While the coupling lens 20 is mounted in the holder 90, the recess C1 overlaps the first flange portion 24B, and specifically the first corner portion 26A, when viewed in the direction along the optical axis X2. While the coupling lens 20 is mounted in the holder 90, the recess C2 overlaps the first flange portion 24A, and specifically the second corner portion 26B, when viewed in the direction along the optical axis X2.

The first flange portion 24B is bonded to the holder 90 by adhesive BD which is located in the recess C1, and the first flange portion 24A is bonded to the holder 90 by adhesive BD which is located in the recess C2. With this configuration, the coupling lens 20 is bonded to the holder 90 with two portions (the first corner portion 26A and second corner portion 26B) that are on opposite sides of the optical axis X2.

The embodiment described above can obtain the following technical advantages.

By exposing at least a portion of the flat surfaces F2 on the second flange portions 25A-25C through the first notches H11-H13, a jig or the like can be made to contact one of the flat surfaces F2 on the second flange portions 25A-25C to set the orientation of the coupling lens 20 around its optical axis X2. Further, by exposing at least a portion of the flat surfaces F2 on the second flange portions 25A-25C through the first notches H11-H13, the orientation of the coupling lens 20 around the optical axis X2 can be easily adjusted.

By positioning the optical axis X2 between two first positioning parts (for example, the first positioning parts 93A and 93B), the coupling lens 20 can be precisely positioned in the radial direction by the two first positioning parts positioned on opposite sides of the optical axis X2.

Since each of the first positioning parts 93A-93D has the curved surface F3 that conforms to the corresponding arcuate surface F1, the coupling lens 20 can be precisely positioned in radial directions by aligning the arcuate surfaces F1 with the curved surfaces F3.

Since the holder 90 has the second positioning parts 94A and 94B opposing the flat surfaces F2 of the second flange portions 25A and 25B, the second positioning parts 94A and 94B can determine the orientation of the coupling lens 20 around the optical axis X2.

Since each of the second positioning parts 94A and 94B has the second flat surface F4 that opposes the flat surface F2 of the corresponding second flange portions 25A and 25B, the orientation of the coupling lens 20 about the optical axis X2 can be determined by aligning the flat surfaces F2 with the second flat surfaces F4.

The first corner portion 26A and the second corner portion 26B of the coupling lens 20 that are positioned on opposite sides of the optical axis X2 are bonded to the holder 90. This configuration can restrict the coupling lens 20 from shifting in position with respect to the radial direction of the optical surface 21 due to shrinkage of the adhesive BD that occurs during curing of the adhesive BD.

By providing the holder 90 with the recesses C1 and C2 that overlap the first flange portions 24A and 24B when viewed in the direction along the optical axis X2 and by positioning the adhesive BD in the recesses C1 and C2, the adhesive BD becomes interposed between the coupling lens 20 and the holder 90 in the direction of the optical axis X2, thereby enabling the first flange portions 24A and 24B to be firmly bonded to the holder 90.

By providing the holder 90 with the second notch H2 for exposing the gate trace 23 in the radial direction, the gate trace 23 does not contact the holder 90 and, hence, does not affect the positioning accuracy for the optical axis X2 of the coupling lens 20.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

In the following description, members that are similar in structure to those in the embodiment are designated with the same reference numerals to avoid duplicating description.

The second positioning parts 94A and 94B in the depicted embodiment are not absolutely necessary. For example, the second positioning parts 94A and 94B may be eliminated from the holder 90 of the above embodiment, as illustrated in FIG. 8. Specifically, referring to FIG. 8, in a holder 290 according to this modification, the flat surfaces F2 on the second flange portions 25A and 25B of the coupling lens 20 can be gripped from both sides of the optical axis X2 with a jig, for example, so that the orientation of the coupling lens 20 around the optical axis X2 can be set by adjusting the angle of the jig.

In the above embodiment, the flange portion 22 of the coupling lens 20 contacts the lens seating surface 91A in the third direction, but the flange portion 22 of the coupling lens 20 need not contact the lens seating surface 91A. Rather, the coupling lens 20 may be bonded to the holder 90 after adjusting the position of the coupling lens 20 relative to the holder 90 in the third direction.

While only a portion of each of the first flange portions 24A and 24B is bonded to the holder 90 in the above embodiment, an entirety of the first flange portion of the disclosure may be bonded to the holder of the disclosure.

All of the adhesive BD is placed in the recesses C1 and C2 in the above embodiment. However, according to the disclosure, a portion of adhesive may be placed in the recess with a remaining portion of the adhesive placed outside the recess, for example.

The optical surface of the disclosure need not be circular when viewed in the direction of the optical axis X2, as described in the embodiment. Further, the optical surface of the disclosure need not be perfectly axisymmetric.

For example, in the above embodiment, the light sources Ls each having the semiconductor laser 10 and coupling lens 20 is employed as an example of a light source of the disclosure. However, the light source of the disclosure is not limited to any specific configuration, provided that the light source can emit a light beam. Additionally, the light source of the disclosure may include a semiconductor laser that possesses a plurality of light-emitting points. In this case, the light source may be configured with a single coupling lens for converting light emitted from the plurality of light-emitting points of a single semiconductor laser into a plurality of light beams.

In the above embodiment, the scanning optical device 1 provided with a plurality of light sources Ls for emitting a plurality of light beams is employed as an example of the scanning optical device of the disclosure. However, the scanning optical device of the disclosure may be configured of a single light source that emits only one light beam, for example.

The coupling lens of the disclosure may be provided with any of various numbers of first flange portions and second flange portions and is not limited to the numbers given in the above embodiment.

The elements described in the above embodiment and variations may be implemented in any combination.

What is claimed is:

1. A light source device comprising:
a semiconductor laser configured to emit light;
a coupling lens configured to convert the light from the semiconductor laser into light beam; and
a holder supporting the coupling lens,
wherein the coupling lens has:
an optical surface defining an optical axis; and
a flange portion protruding outward in a radial direction orthogonal to the optical axis, the flange portion comprising:
a first flange portion having an arcuate surface centered on the optical axis; and
a second flange portion having a flat surface extending in a direction along the optical axis,
wherein the holder has:
a first positioning part opposing the arcuate surface in the radial direction for positioning of the coupling lens relative to the holder; and
a first notch through which at least a part of the flat surface is exposed in the radial direction, and
wherein at least a part of the first flange portion is bonded to the holder.

2. The light source device according to claim 1,
wherein the holder comprises two of the first positioning part, the optical axis being positioned between the two of the first positioning part.

3. The light source device according to claim 1,
wherein the first positioning part has a curved surface that conforms to the arcuate surface.

4. The light source device according to claim 1,
wherein the holder further comprises a second positioning part opposing the flat surface of the second flange portion to determine an orientation of the coupling lens about the optical axis.

5. The light source device according to claim 4,
wherein the second positioning part has a second flat surface opposing the flat surface of the second flange portion.

6. The light source device according to claim 1,
wherein the coupling lens has two portions that are bonded to the holder, the two portions being positioned opposite each other with respect to the optical axis.

7. The light source device according to claim 1,
wherein the holder further comprises a recess that is recessed in a direction away from the first flange portion, the recess overlapping with the first flange portion when viewed in the direction along the optical axis, and
wherein the first flange portion is bonded to the holder by an adhesive, at least a portion of the adhesive being positioned in the recess.

8. The light source device according to claim 1,
wherein the coupling lens further has a gate trace protruding outward in the radial direction from the arcuate surface, and
wherein the holder has a second notch through which the gate trace is exposed in the radial direction.

9. The light source device according to claim 1, further comprising a laser holder holding the semiconductor laser and the holder.

10. The light source device according to claim 9,
wherein the holder is bonded to the laser holder.

11. A scanning optical device comprising:
a semiconductor laser configured to emit light;
a coupling lens configured to convert the light from the semiconductor laser into light beam;
a holder supporting the coupling lens;
a deflector comprising a polygon mirror configured to deflect the light beam;
a scanning optical system configured to form an image on an image plane using the light beam from the polygon mirror; and
a frame to which the semiconductor laser, the coupling lens, the holder, the deflector, and the scanning optical system are fixed,
wherein the coupling lens has:
an optical surface defining an optical axis; and
a flange portion protruding outward in a radial direction orthogonal to the optical axis, the flange portion comprising:
a first flange portion having an arcuate surface centered on the optical axis; and
a second flange portion having a flat surface extending in a direction along the optical axis,
wherein the holder has:
a first positioning part opposing the arcuate surface in the radial direction for positioning of the coupling lens relative to the holder; and
a first notch through which at least a part of the flat surface is exposed in the radial direction, and
wherein at least a part of the first flange portion is bonded to the holder.

12. The scanning optical device according to claim 11,
wherein the holder comprises two of the first positioning part, the optical axis being positioned between the two of the first positioning part.

13. The scanning optical device according to claim 12,
wherein the first positioning part has a curved surface that conforms to the arcuate surface.

14. The scanning optical device according to claim 11,
wherein the holder further comprises a second positioning part opposing the flat surface of the second flange portion to determine an orientation of the coupling lens about the optical axis.

15. The scanning optical device according to claim 14,
wherein the second positioning part has a second flat surface opposing the flat surface of the second flange portion.

16. The scanning optical device according to claim 11,
wherein the coupling lens has two portions that are bonded to the holder, the two portions being positioned opposite each other with respect to the optical axis.

17. The scanning optical device according to claim 11,
wherein the holder further comprises a recess that is recessed in a direction away from the first flange portion, the recess overlapping with the first flange portion when viewed in the direction along the optical axis, and
wherein the first flange portion is bonded to the holder by an adhesive, at least a portion of the adhesive being positioned in the recess.

18. The scanning optical device according to claim 11,
wherein the coupling lens further has a gate trace protruding outward in the radial direction from the arcuate surface, and
wherein the holder has a second notch through which the gate trace is exposed in the radial direction.

19. The scanning optical device according to claim 11, further comprising a laser holder holding the semiconductor laser and the holder,
wherein the laser holder is fixed to the frame.

20. The scanning optical device according to claim 19,
wherein the holder is bonded to the laser holder.
